(19) United States
(12) Patent Application Publication
(10) Pub. No.: US 2026/0162023 A1
(43) Pub. Date: Jun. 11, 2026

(54) INTELLIGENTLY PERFORMING NODE SCALE-OUT FOR CLUSTERS IN A DISTRIBUTED COMPUTING ENVIRONMENT

(71) Applicant: INTERNATIONAL BUSINESS MACHINES CORPORATION, Armonk, NY (US)

(72) Inventors: Abhishek MALVANKAR, White Plains, NY (US); Derek Wayne CARR, Apex, NC (US)

(21) Appl. No.: 18/975,032

(22) Filed: Dec. 10, 2024

(51) Int. Cl. G06N 20/20; G06F 18/2321

(52) U.S. Cl. CPC G06N 20/20; G06F 18/2321

(57) ABSTRACT

A computer-implemented method includes: receiving a user workload in a cluster in a distributed computing environment; identifying a current workload in the cluster using a similarity analysis; predicting, using a first machine learning model, a first time to complete execution of the current workload; predicting, using a second machine learning model, a second time to acquire resources from outside the cluster to execute the user workload; and based on comparing the first time to the second time, performing one of: delaying acquiring the resources from outside the cluster based on the first time being less than the second time; and acquiring the resources from outside the cluster based on the first time being greater than the second time.

### BACKGROUND

Aspects of the present invention relate generally to controlling computing operations in a distributed computing environment and, more particularly, to controlling scaling operations in a cluster in a distributed computing environment.

Cloud computing infrastructures are becoming increasingly popular due to their increased scalability, agility, and elasticity as well as the ability to provision resources to meet increased customer requirements. Many cloud computing infrastructures provide services via containerized workloads. A container orchestration system is used for automating the deployment, sizing, and management of workloads in containers.

### SUMMARY

In a first aspect of the invention, there is a computer-implemented method including: receiving a user workload in a cluster in a distributed computing environment; identifying a current workload in the cluster using a similarity analysis; predicting, using a first machine learning model, a first time to complete execution of the current workload; predicting, using a second machine learning model, a second time to acquire resources from outside the cluster to execute the user workload; and based on comparing the first time to the second time, performing one of: delaying acquiring the resources from outside the cluster based on the first time being less than the second time; and acquiring the resources from outside the cluster based on the first time being greater than the second time.

In another aspect of the invention, there is a computer program product comprising one or more computer-readable storage media and program instructions stored on the one or more computer-readable storage media to perform operations comprising: receiving a user workload in a cluster in a distributed computing environment; identifying a current workload in the cluster using a similarity analysis; predicting, using a first machine learning model, a first time to complete execution of the current workload; predicting, using a second machine learning model, a second time to acquire resources from outside the cluster to execute the user workload; and based on comparing the first time to the second time, performing one of: delaying scale-out for the user workload based on the first time being less than the second time; and performing scale-out for the user workload based on the first time being greater than the second time.

In another aspect of the invention, there is a computer system comprising a processor set, one or more computer-readable storage media, and program instructions stored on the one or more computer-readable storage media to cause the processor set to perform operations comprising: queuing a user workload in a cluster in a containerized environment in a distributed computing environment; identifying a current workload in the cluster using a similarity analysis; predicting, using a first machine learning model, a first time to complete execution of the current workload; predicting, using a second machine learning model, a second time to acquire resources from outside the cluster to execute the user workload; and based on comparing the first time to the second time, performing one of: delaying scale-out for the user workload based on the first time being less than the second time; and performing scale-out for the user workload based on the first time being greater than the second time.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows an example of training data that may be used to train the first machine learning model in accordance with aspects of the invention.

FIG. 5 shows an example of training data that may be used to train the second machine learning model in accordance with aspects of the invention.

FIG. 6 shows a flowchart of an exemplary method in accordance with aspects of the present invention.

FIG. 7 shows a flowchart of an exemplary method in accordance with aspects of the present invention.

### DETAILED DESCRIPTION

Aspects of the present invention relate generally to controlling computing operations in a distributed computing environment and, more particularly, to controlling scaling operations in a cluster in a distributed computing environment. In accordance with aspects of the invention, a system and method are configured to delay node scale-out of a cluster by using a trained machine learning model to predict job runtime, a trained machine learning model to predict time required to acquire nodes in the cluster, and a comparison of the predicted times. In various embodiments, the system and method use a green computing dimension such as carbon intensity to predict time required to acquire nodes in the cluster. In embodiments, the system and method identify similar jobs running in the cluster to determine scale-out. In this manner, implementations select an optimal start time for a next job in the cluster based on a predicted time of the previous job running in the cluster. By selecting an optimal start time for a next job based on the comparison using the machine learning models, implementations optimize cost to perform the job and streamline scale-out when multiple competing users need node scale-out.

Foundational models used in generative artificial intelligence (AI) systems are often trained using cloud resources. A large number of graphics processing units (GPUs) are typically required for processing the very large workloads involved in training a foundational model. For example, training a foundational model may involve workloads that require tens of GPUs. Because GPUs are currently in high demand and short supply, it can be difficult to acquire a sufficient number of GPUs to perform the workload to train a foundational model.

Moreover, adding to the difficulty in acquiring resources to train such models, most foundational model workloads require that all the resources, including the GPUs, be available at a same time to enable the computations involved in the workloads. Such workloads cannot be incrementally processed with less than the required number of GPUs. For example, if a foundational model workload requires twenty GPUs, then the workload cannot be started until all twenty GPUs are acquired and configured. This ‘all or nothing’ type of requirement poses a problem for customers wishing to acquire GPUs for training their foundational models, since the customer typically must pay for GPUs they have acquired but which are sitting idle while the customer waits for the full number of required GPUs to be acquired.

One approach for acquiring cloud resources for executing workloads in a cluster in a containerized environment is to use a cluster autoscaler. In this approach, cloud resources are arranged on nodes in a cluster, and the cluster autoscaler adds nodes to the cluster based on demand. Acquiring the cloud resources and adding them as nodes in a cluster in this manner may be referred to as node scale-out of the cluster. However, acquiring GPUs from a cloud provider can involve large amounts of time (e.g., from several minutes to several hours) based on factors such as the time of day and the demand a zone has on a given day. Moreover, after acquiring a GPU from a cloud provider, adding that GPU to a cluster takes additional time because a node containing the GPU must be configured (e.g., with specific software such as Node Feature Discovery (NFD) and GPU operators) before the node is added to the cluster. All of these processes contribute to the amount of time it takes to complete the node scale-out of a cluster that will execute workloads for training foundational models. The autoscaler approach combined with the long times to acquire GPUs creates inefficiencies for customers who utilize many GPUs for a workload (e.g., for training a foundational model), since this often causes the customers to pay for GPUs that are acquired during scale-out and that are sitting idle in the cluster while waiting for the autoscaler to acquire the total number of GPUs needed to complete the cluster.

Implementations of the invention address these problems by providing a system and method that optimize decision-making for whether to delay or immediately perform a node scale-out for a workload in a cluster. In accordance with aspects of the invention, for a next workload in a queue of a cluster, the system and method utilize machine learning models to predict whether resources already in the cluster will become available for the next workload before an estimated time to acquire additional nodes to perform the next workload. In embodiments, the system and method use a first machine learning model to predict a first amount of time to finish a workload in the cluster that has similar resource requirements as the next workload. In embodiments, the system and method use a second machine learning model to predict a second amount of time needed to acquire cloud resources from outside the cluster to perform the next workload (e.g., perform a scale-out for the next workload). In one example, if the first time (e.g., the time to finish a current workload having a similar resource requirement as the next workload) is less than the second time (e.g., the time to acquire new resources for the next workload), then the node scale-out for the next workload is delayed since resources will become available within the cluster faster than the scale-out can be accomplished. In another example, if the second time is less than the first time, then the scale-out is performed since scale-out can be completed before other resources become available in the cluster. In this manner, implementations of the invention intelligently decide when to perform a scale-out for a workload in a cluster, the decision being made in a manner that reduces or entirely avoids the inefficiencies associated with current approaches to scale-out. In this manner, implementations of the invention provide an improvement in the technical field of controlling scaling operations in a cluster in a distributed computing environment.

Implementations permit a user to add a foundational model workload to a queue of a cluster in a containerized environment in a distributed computing environment. The queue may be maintained by a multi-cluster-app-dispatcher, which queues workloads when aggregated resources are not available in the cluster. In embodiments, a controller works with the multi-cluster-app-dispatcher to get aggregated resources available in the cluster to run workloads in the cluster. The controller may use taints and tolerations to attract and repel jobs from nodes in the cluster. In various embodiments, the time needed to acquire the nodes and configure the nodes on the target cluster is recorded for previous workloads, and when a next workload enters the system a discovery process is performed to find previous workloads (i.e., workloads that are currently being executed in the cluster) that have a with similar resource requirement as the next workload. In implementations, a first machine learning model predicts the job runtime estimation of the previous workload, and a second machine learning model predicts the time needed to acquire another set of nodes for the next workload. In embodiments, if the predicted job runtime estimation is less that predicted time to acquire another set of nodes, then scale-out is delayed. Implementations may be configured to consider features such as carbon intensity when determining and comparing predicted job runtime estimation predicted time to acquire another set of nodes.

Implementations of the invention are necessarily rooted in computer technology. For example, the steps of receiving a user workload in a cluster in a distributed computing environment, predicting, using a first machine learning model, a first time to complete execution of the current workload, and predicting, using a second machine learning model, a second time to acquire resources from outside the cluster to execute the user workload, are computer-based and cannot be performed in the human mind. Receiving a user workload in a cluster in a distributed computing environment can only be performed by a computing device in the cluster and cannot be performed in the human mind or with pen and paper. Moreover, training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as scale-out optimization code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

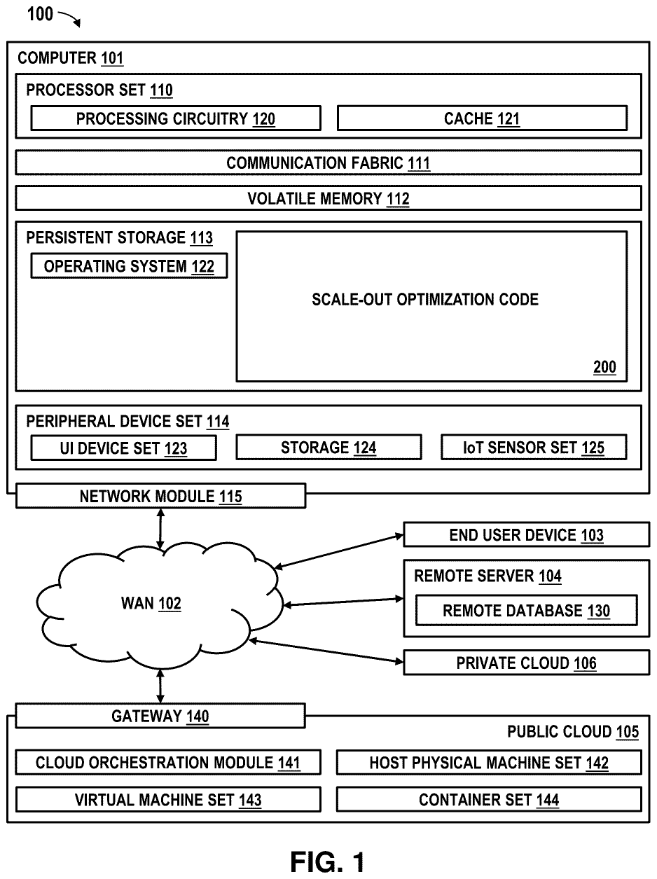

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

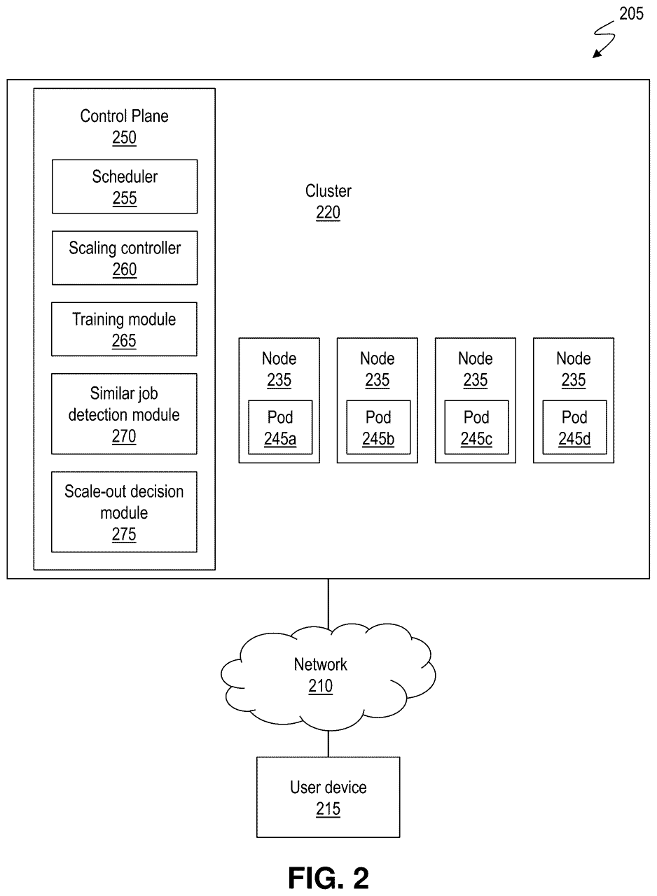

FIG. 2 shows a block diagram of an exemplary environment 205 in accordance with aspects of the invention. In embodiments, the environment 205 includes a network 210 that provides electronic communication between a user device 215 and a cluster 220 that provides online services to the user device 215. The network 210 may correspond to the WAN 102 of FIG. 1. The user device 215 may correspond to the EUD 103 of FIG. 1. There is one user device 215 shown in the example of FIG. 2; however, there may be any number of user devices 215 communicating with the cluster 220.

In embodiments, the cluster 220 is a computing cluster including nodes 235 that run containerized applications that provide online services to the user device 215. In a particular example, the cluster 220 is a Kubernetes cluster. Each node 235 may comprise a computing device (e.g., a bare-metal server or virtual machine) that hosts one or more pods 245a-d. As is understood in the art, pods contain one or more containers, such as Docker containers. As such, the cluster 220 is in a containerized environment in a distributed computing environment. The pods 245a-d run on nodes 235 and represent a single instance of a running process in the cluster 220. There are four nodes 235 shown in the example of FIG. 2; however, there may be any number of the nodes 235 in the cluster 220, and there may be any number of pods on each node. Plural pods associated with the same service may run on different nodes, and plural pods associated with different services may run on the same node.

Still referring to FIG. 2, the cluster 220 includes a control plane 250 that manages the nodes 235 and the pods 245a-d in the cluster 220. The control plane 250 may run on one or more nodes (not shown) similar to the nodes 235. For example, the control plane 250 may run on one or more instances of the computer 101 of FIG. 1. In various embodiments, the control plane 250 includes a scheduler 255 that watches for newly created pods with no assigned node and selects a node for them to run on. In one example, the scheduler 255 comprises a multi-cluster-app-dispatcher (MCAD) which is a Kubernetes controller that manages workloads (e.g., jobs) in a cluster, for example, by queuing workload creation requests, applying different queuing policies, and dispatching workloads to node(s) within the cluster. In embodiments, the control plane 250 also includes a scaling controller 260 that is configured to scale a workload for a service to match demand for the service. In one example, the scaling controller 260 comprises an InstaScale controller, which is a controller that works with the multi-cluster-app-dispatcher to get aggregated resources available in the cluster to run workloads in the cluster. In accordance with aspects of the invention, the scaling controller 260 may scale a workload for a service using horizontal scaling in which the scaling controller 260 deploys more pods to handle a workload. For example, in response to determining there is an increased demand for a service provided by the pods 245a-d, the scaling controller 260 may acquire additional instances of nodes 235 from outside the cluster 220 to assist with the workload for this service.

In embodiments, the control plane 250 of FIG. 2 comprises a training module 265, a similar job detection module 270, and a scale-out decision module 275, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The control plane 250 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the training module 265 is configured to train first and second machine learning models that are used by the scale-out decision module 275. In embodiments, the first machine learning model is a model that is trained to predict a first amount of time to finish one or more workloads currently running in the cluster 220. In embodiments, the second machine learning model is a model that is trained to predict a second amount of time needed to acquire resources, from outside the cluster 220, that would be sufficient to execute a workload in the queue in the cluster 220.

In accordance with aspects of the invention, the similar job detection module 270 is configured to determine whether a workload currently running in the cluster 220 has a similar resource requirement a workload in the queue in the cluster 220. In embodiments, the similar job detection module 270 determines whether a workload currently running in the cluster 220 has a similar resource requirement as a workload in the queue using a similarity analysis that is based on comparing resources such as: (i) number of CPUs (computer processing units) required for each workload; (ii) amount of memory required for each workload; and (iii) number of GPUs required for each workload.

In accordance with aspects of the invention, the scale-out decision module 275 is configured to determine whether to immediately perform scale-out for a workload in the queue in the cluster 220 or to delay the scale-out. In embodiments, the scale-out decision module 275 makes this determination using two respective times predicted by the first and second machine learning models that are trained by the training module 265. In embodiments, if a first time predicted by the first machine learning model (e.g., a time to finish the workload currently running in the cluster 220 that has a similar resource requirement as the workload in the queue of the cluster 220) is less than a second time predicted by the second machine learning model (e.g., the time to acquire other resources for the foundational model workload), then the scale-out decision module 275 instructs the scaling controller 260 to delay (e.g., not perform) a scale-out for the workload in the queue of the cluster 220. In another example, if the second time is less than the first time, then the scale-out decision module 275 instructs the scaling controller 260 to immediately proceed with performing a scale-out for the workload in the queue of the cluster 220.

An exemplary use case performed in the environment of FIG. 2 will now be described to illustrate aspects of the present invention. In this exemplary use case, the user device 215 sends a request to the cluster 220 to train a foundational model that will be used in generative AI system. In this use case, the scheduler 255 creates a foundational model workload (e.g., job) corresponding to the request to train the foundational model and puts the foundational model workload in a queue (e.g., an MCAD queue). The queue may include one or more other workloads that are currently being performed in the cluster and/or one or more other workloads that are queued to be performed in the cluster 220.

In this use case, when the foundational model workload is the next workload in the queue, the similar job detection module 270 determines whether a workload currently running in the cluster 220 has a similar resource requirement as the foundational model workload. In embodiments, similarity of workloads is determined using a similarity analysis that is based on comparing resources associated with (e.g., included in or available to) the nodes 235 in the cluster 220, the resources including: (i) number of CPUs required for each workload; (ii) amount of memory required for each workload; and (iii) number of GPUs required for each workload. A workload currently running in the cluster 220 is deemed to have a similar resource requirement as the foundational model workload if: (i) the workload currently running in the cluster 220 requires a number of CPUs that is equal to or greater than the number of CPUs required by the foundational model workload; (ii) the workload currently running in the cluster 220 requires an amount of memory that is equal to or greater than the amount of memory required by the foundational model workload; and (iii) the workload currently running in the cluster 220 requires a number of GPUs that is equal to or greater than the number of GPUs required by the foundational model workload. The workload currently running in the cluster 220 may comprise plural workloads currently running the cluster. In this situation, the a similar resource requirement is determined by comparing the cumulative amount of CPUs, memory, and GPUs of the plural workloads to the number of CPUs, memory, and GPUs of the foundational model workload.

In this use case, if a workload currently running in the cluster 220 does not have a similar resource requirement as the foundational model workload, then the similar job detection module 270 instructs the scaling controller 260 to proceed immediately with scale-out for the foundational model workload. In this use case, if a workload currently running in the cluster 220 does have a similar resource requirement as the foundational model workload, then the scale-out decision module 275 determines whether to proceed immediately with scale-out for the foundational model workload or to delay scale-out and wait for resources within the cluster 220 to become available. As described herein, the scale-out decision module 275 makes this determination using two respective times predicted by two respective machine learning models. The scale-out decision module 275 uses the first machine learning model to predict a first amount of time to finish the workload currently running in the cluster 220 that has a similar resource requirement as the foundational model workload. The scale-out decision module 275 uses the second machine learning model to predict a second amount of time needed to acquire other resources from outside the cluster 220, where the other resources would be sufficient to execute the foundational model workload. The scale-out decision module 275 determines whether to proceed immediately with scale-out for the foundational model workload or to delay scale-out based on comparing the first time to the second time. In one example, if the first time (e.g., the time to finish the workload currently running in the cluster 220 that has a similar resource requirement as the foundational model workload) is less than the second time (e.g., the time to acquire other resources for the foundational model workload), then the scale-out decision module 275 instructs the scaling controller 260 to delay (e.g.. not perform) a scale-out for the foundational model workload since resources will become available within the cluster 220 faster than the scale-out can be accomplished. In another example, if the second time is less than the first time, then the scale-out decision module 275 instructs the scaling controller 260 to immediately proceed with performing a scale-out for the foundational model workload since scale-out can be completed before other resources become available in the cluster 220. In this manner, implementations of the invention intelligently decide when to perform a scale-out for a workload in the cluster 220.

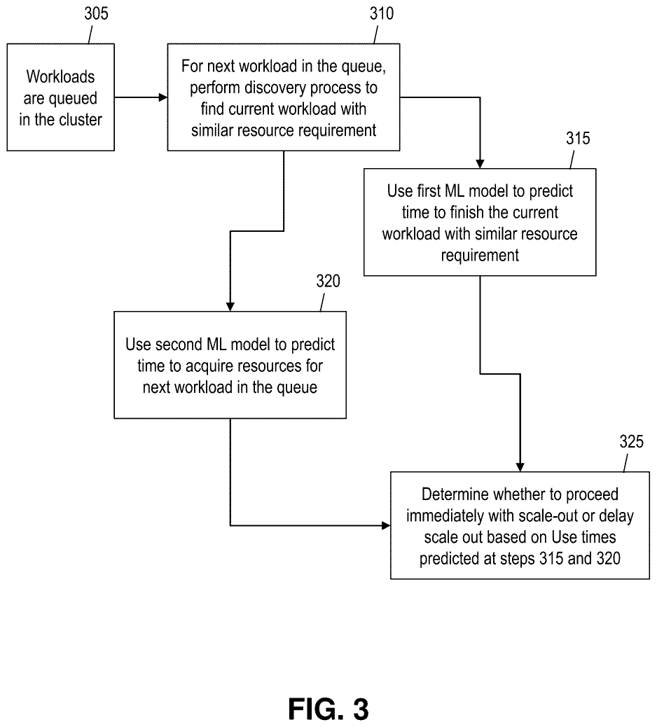

FIG. 3 shows a flowchart of an exemplary method in accordance with aspects of the present invention. Steps of the method (also called operations) may be carried out in the environment of FIG. 2 and are described with reference to elements depicted in FIG. 2.

At step 305, the system queues workloads in a queue in a containerized computing environment. In embodiments, and as described with respect to FIG. 2, the queue may be maintained by a multi-cluster-app-dispatcher in the scheduler 255.

At step 310, for a next workload in the queue, the system performs a discovery process to identify a current workload that has a similar resource requirement as the next workload in the queue. In embodiments, and as described with respect to FIG. 2, the similar job detection module 270 performs the discovery process by performing a similarity analysis that compares the CPUs, memory, and GPUs required for the next workload in the queue to the CPUs, memory, and GPUs being used with one or more current workloads in the cluster.

At step 315, the system predicts a time to finish the current workload that was discovered at step 310 that has a similar resource requirement as the next workload in the queue. In embodiments, and as described with respect to FIG. 2, the scale-out decision module 275 uses the first machine learning model to predict a time to finish the current workload.

At step 320, the system predicts a time to acquire resources for running the next workload in the queue. In embodiments, and as described with respect to FIG. 2, the scale-out decision module 275 uses the second machine learning model to predict a time to acquire resources.

At step 325, the system determines whether to proceed immediately with scale-out or delay scale out. In embodiments, and as described with respect to FIG. 2, the scale-out decision module 275 makes this determination based on the respective times predicted at steps 320 and 325.

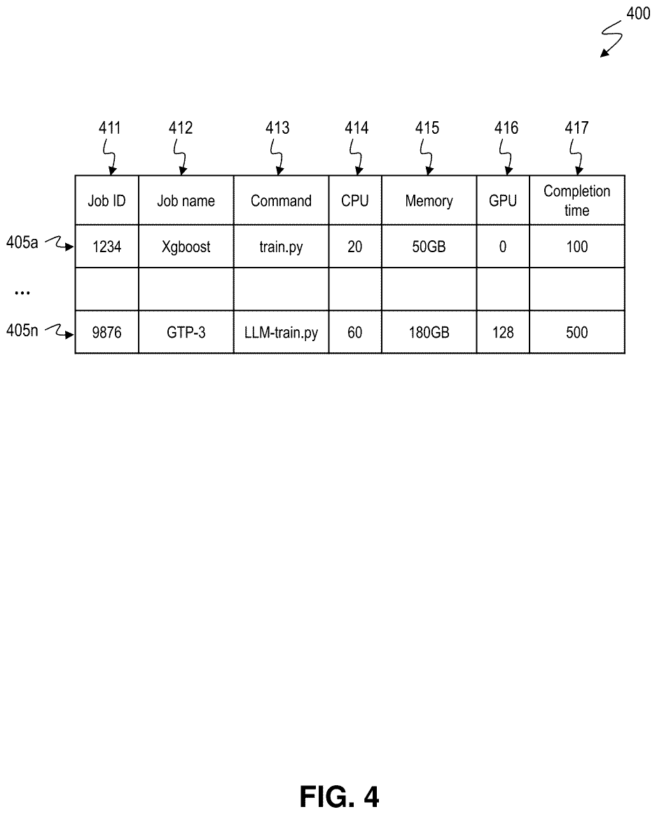

FIG. 4 shows an example of training data 400 that may be used to train the first machine learning model in accordance with aspects of the invention. In embodiments, the first machine learning model comprises a regression model that receives an input and that outputs a predicted time to finish a workload currently running in the cluster 220. In one example, the first machine learning model comprises an artificial neural network that is trained using training data associated with historic jobs run in the cluster 220 and/or other clusters. In FIG. 4, each row 405a-n comprises a dataset associated with a historic job, where “n” may be any integer. In this example, each dataset includes data associated with respective attributes in columns 411-417 including Job ID, Job name, Command, CPU, Memory, GPU, and Completion time. Job ID may refer to an identifier associated with the job, such as a job number. Job name may refer to a name assigned to a job. Command may refer to a command included in the job. CPU may refer to a number of CPUs used by nodes in a cluster for executing the job. Memory may refer to an amount of memory used by nodes in a cluster for executing the job. GPU may refer to a number of GPUs used by nodes in a cluster for executing the job. Completion time may refer to the amount of time (e.g., real world time) it took to execute the job in the cluster. In this example, in each row 405a-n, the values in columns 411-416 are a respective set of input values and the value in column 417 is a label (e.g., a target value) that the first machine learning model is trained to output based on the respective set of inputs. In embodiments, the training module 265 uses the training data 400 to train the first machine learning model using neural network training techniques, e.g., creating an artificial neural network including weights that represent connections between nodes in different layers of the model, and adjusting values of these weights (e.g., via backpropagation or stochastic gradient descent) to minimize a loss function, until the model accurately predicts the respective target values in column 417 in response to the respective sets of input values in columns 411-416.

With continued reference to the first machine learning model, the scale-out decision module 275 may use the trained first machine learning model to predict the time to finish the workload currently running in the cluster 220. In embodiments, the scale-out decision module 275 provides an input to the first machine learning model. The input comprises a dataset with values for columns 411-416, for example, where these values are associated with the workload currently running in the cluster 220. Based on this input, the first machine learning model generates an output, which is the predicted completion time for the workload currently running in the cluster 220. In embodiments, priority data can be further added to the training data to handle cases of preemption. For example, if a high priority job is in the queue, then it might preempt other jobs based on priority data, and the first machine learning model can be trained to account for this. In this manner, the first machine learning model can be used when multiple competing users are requesting resources for scale-out.

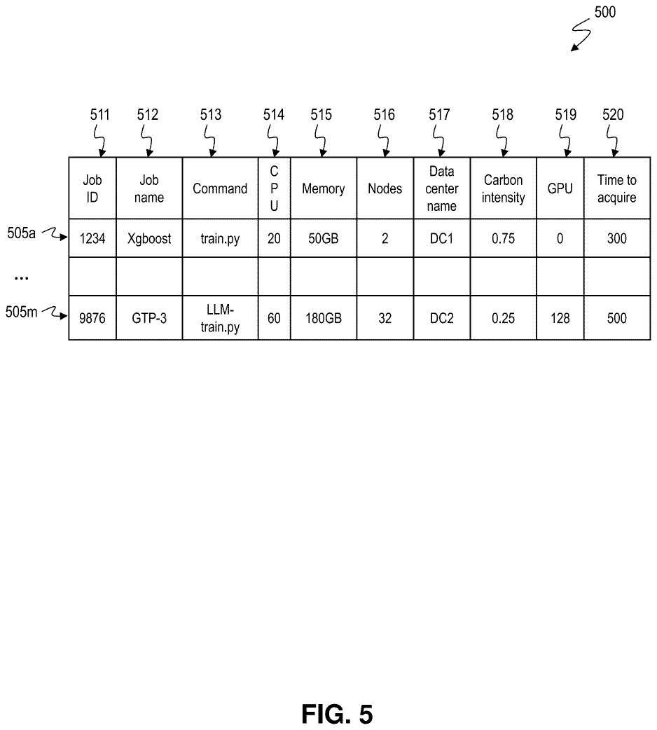

FIG. 5 shows an example of training data 500 that may be used to train the second machine learning model in accordance with aspects of the invention. In embodiments, the second machine learning model comprises a regression model that receives an input and that outputs a predicted a time needed to acquire resources, from outside the cluster 220, that would be sufficient to execute a workload in the queue in the cluster 220. In one example, the second machine learning model comprises an artificial neural network that is trained using training data associated with historic jobs that were scaled-out in the cluster 220 and/or other clusters. In FIG. 5, each row 505a-m comprises a dataset associated with a historic job, where “m” may be any integer. In this example, each dataset includes data associated with respective attributes in columns 511-520 including Job ID, Job name, Command, CPU, Memory, Nodes, Data center name, Carbon intensity, GPU, and Time to acquire. Job ID may refer to an identifier associated with the job, such as a job number. Job name may refer to a name assigned to a job. Command may refer to a command included in the job. CPU may refer to a number of CPUs used by nodes in a cluster for executing the job. Memory may refer to an amount of memory used by nodes in a cluster for executing the job. Number of nodes may refer to a number of nodes in the cluster needed to execute the job. Data center name may refer to the name of a data center from which resources are acquired in the scale-out. Carbon intensity may refer to a carbon intensity (CI) score associated with the data center from which resources are acquired in the scale-out. In some examples, these scores are published by data centers and/or public entities and may be used as a relative measure of how green a data center is during operation. GPU may refer to a number of GPUs used by nodes in a cluster for executing the job. Time to acquire may refer to the amount of time (e.g., real world time) it took to acquire the resources during the scale-out. In this example, in each row 505a-m, the values in columns 511-519 are a respective set of input values and the value in column 520 is a label (e.g., a target value) that the second machine learning model is trained to output based on the respective set of inputs. In embodiments, the training module 265 uses the training data 500 to train the second machine learning model using neural network training techniques, e.g., creating an artificial neural network including weights that represent connections between nodes in different layers of the model, and adjusting values of these weights (e.g., via backpropagation or stochastic gradient descent) to minimize a loss function, until the model accurately predicts the respective target values in column 520 in response to the respective sets of input values in columns 511-519.

With continued reference to the second machine learning model, the scale-out decision module 275 may use the trained second machine learning model to predict a time needed to acquire resources, from outside the cluster 220, that would be sufficient to execute a next workload in the queue in the cluster 220. In embodiments, the scale-out decision module 275 provides an input to the second machine learning model. The input comprises a dataset with values for columns 511-519, for example, where these values correspond to measures of the resources needed to execute the next workload in the queue in the cluster 220. Based on this input, the second machine learning model generates an output, which is the predicted time to acquire resources that would be sufficient to execute the next workload in the queue in the cluster 220 (e.g., a predicted time to complete scale-out for this workload). In embodiments, the acquire time for scale-out of previous workloads in the cluster 220 is used as the training data. In embodiments, the data center name and carbon intensity values provide a green computing feature to the prediction time.

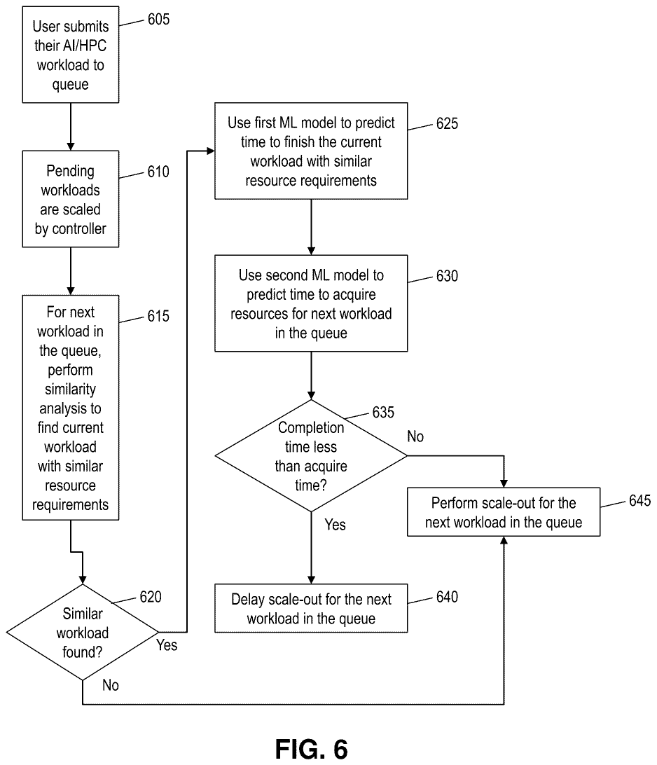

FIG. 6 shows a flowchart of an exemplary method in accordance with aspects of the present invention. Steps of the method (also called operations) may be carried out in the environment of FIG. 2 and are described with reference to elements depicted in FIG. 2.

At step 605, a user utilizing the user device 215 submits an artificial intelligence (AI) or high-performance computing (HPC) workload to the queue of the scheduler 255 in the cluster 220. At step 610, the scaling controller 260 scales ones of the workloads in the queue using resources already in the cluster 220. At step 615, when the user workload from step 605 is the next workload in the queue, the similar job detection module 270 perform similarity analysis to find a current workload with similar resource requirement as the user workload. In embodiments, this may be performed in the manner described at step 310 of FIG. 3 and as described at FIG. 2, e.g., by comparing (i) amounts of resources (e.g., CPU, memory, GPU) determined to be used for executing the user workload to (ii) amounts of resources currently being used by workloads that are currently being executed in the cluster. In this manner, the similarity analysis is based on a first set of resources used by the current workload and a second set of resources associated with the user workload.

At step 620, the similar job detection module 270 determines whether a current workload having similar resources requirements was found at step 615. If a current workload having similar resources requirements was not found at step 615, then the process proceeds to step 645. If a current workload having similar resources requirements was found at step 615, then the process proceeds to step 625.

At step 625, the scale-out decision module 275 uses the first machine learning model to predict a time to finish the current workload with similar resource requirements (e.g., the current workload found at step 615). In embodiments, this may be performed in the manner described at step 315 of FIG. 3 and as described at FIGS. 2 and 4.

At step 630, the scale-out decision module 275 uses the second machine learning model to predict a time to acquire resources for the next workload in the queue (e.g., the resources needed for the user workload from step 605). In embodiments, this may be performed in the manner described at step 320 of FIG. 3 and as described at FIGS. 2 and 5.

At step 635, the scale-out decision module 275 determines whether the current workload completion time (from step 625) is less than the time to acquire resources (from step 630). In one example, if the current workload completion time is less than the time to acquire resources, then at step 640 the scale-out decision module 275 instructs the scaling controller 260 to delay performing the scale-out for the next workload in the queue (e.g., the user workload from step 605). In this example, during the delay of scale-out, the system waits for resources within the cluster 220 to free up, and then uses these resources to execute the next workload in the queue (e.g., the user workload from step 605) without acquiring additional resources from outside the cluster 220. In another example, if the current workload completion time is not less than the time to acquire resources, then at step 645 the scaling controller 260 performs the scale-out for the next workload in the queue (e.g., the user workload from step 605). In this example, the scaling controller 260 proceeds with acquiring additional resources (e.g., additional GPUs) from outside the cluster 220 to use for executing the next workload in the queue (e.g., the user workload from step 605).

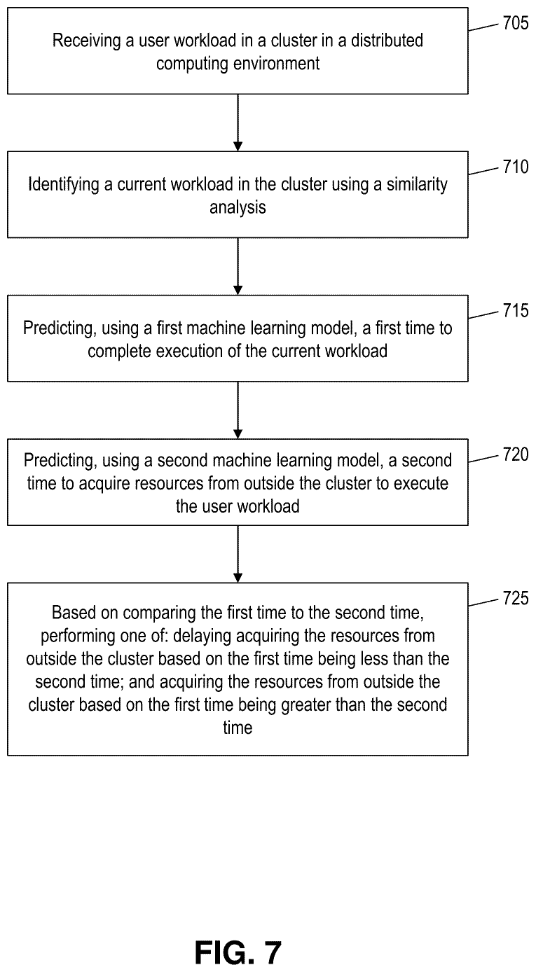

FIG. 7 shows a flowchart of an exemplary method in accordance with aspects of the present invention. Steps of the method (also called operations) may be carried out in the environment of FIG. 2 and are described with reference to elements depicted in FIG. 2.

At step 705, the system receives a user workload in a cluster in a distributed computing environment. In embodiments, and as described with respect to FIG. 2, the cluster 220 receives a user request for the user workload from the user device 215. In some examples, the user workload is an AI/HPC workload, such as a request to train a foundational model.

At step 710, the system identifies a current workload in the cluster using a similarity analysis. In embodiments, and as described with respect to FIG. 2, the similar job detection module 270 identifies a current workload in the cluster 220 that has a similar resource requirement to the user workload from step 705.

At step 715, the system predicts, using a first machine learning model, a first time to complete execution of the current workload. In embodiments, and as described with respect to FIG. 2, the scale-out decision module 275 predicts the first time using the first machine learning model.

At step 720, the system predicts, using a second machine learning model, a second time to acquire resources from outside the cluster to execute the user workload. In embodiments, and as described with respect to FIG. 2, the scale-out decision module 275 predicts the second time using the second machine learning model.

At step 725, based on comparing the first time to the second time, the system performs one of: delaying acquiring the resources from outside the cluster based on the first time being less than the second time; and acquiring the resources from outside the cluster based on the first time being greater than the second time. In embodiments, and as described with respect to FIG. 2, the scale-out decision module 275 causes the cluster 220 to delay scale-out for the user workload or to immediately proceed with scale-out for the user workload.

In embodiments of the method, the first machine learning model comprises a first regression model that is trained to predict the first time based on a first set of inputs, and the second machine learning model comprises a second regression model that is trained to predict the second time based on a second set of inputs. In embodiments the first machine learning model is different than the second machine learning model, and the first set of inputs is different than the second set of inputs. In embodiments, the second set of inputs include a carbon intensity value.

In embodiments of the method, the user workload comprises a foundational model workload. In embodiments of the method, the resources from outside the cluster comprise one or more graphics processing units that are not currently in the cluster. In embodiments of the method, the similarity analysis is based on resources used by the current workload and resources needed by the user workload.

In embodiments, the method further comprises placing the user workload in a queue in the cluster. In embodiments, the identifying the current workload, the predicting the first time, and the predicting the second time are performed while the user workload is in the queue. In embodiments, the current workload is being executed in the cluster while the user workload is in the queue.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a user workload in a cluster in a distributed computing environment;
identifying a current workload in the cluster using a similarity analysis;
predicting, using a first machine learning model, a first time to complete execution of the current workload;
predicting, using a second machine learning model, a second time to acquire resources from outside the cluster to execute the user workload; and
based on comparing the first time to the second time, performing one of:
delaying acquiring the resources from outside the cluster based on the first time being less than the second time; and
acquiring the resources from outside the cluster based on the first time being greater than the second time.

2. The computer-implemented method of claim 1, wherein:
the first machine learning model comprises a first regression model that is trained to predict the first time based on a first set of inputs; and
the second machine learning model comprises a second regression model that is trained to predict the second time based on a second set of inputs.

3. The computer-implemented method of claim 2, wherein:
the first machine learning model is different than the second machine learning model; and
the first set of inputs is different than the second set of inputs.

4. The computer-implemented method of claim 2, wherein the second set of inputs include a carbon intensity value.

5. The computer-implemented method of claim 1, wherein the user workload comprises a foundational model workload.

6. The computer-implemented method of claim 1, wherein the resources from outside the cluster comprise one or more graphics processing units that are not currently in the cluster.

7. The computer-implemented method of claim 1, wherein the similarity analysis is based on a first set of resources used by the current workload and a second set of resources associated with the user workload.

8. The computer-implemented method of claim 1, further comprising placing the user workload in a queue in the cluster.

9. The computer-implemented method of claim 8, wherein the identifying the current workload, the predicting the first time, and the predicting the second time are performed while the user workload is in the queue.

10. The computer-implemented method of claim 9, wherein the current workload is being executed in the cluster while the user workload is in the queue.

11. A computer program product comprising:
one or more computer-readable storage media; and
program instructions stored on the one or more computer-readable storage media to perform operations comprising:
receiving a user workload in a cluster in a distributed computing environment;
identifying a current workload in the cluster using a similarity analysis;
predicting, using a first machine learning model, a first time to complete execution of the current workload;
predicting, using a second machine learning model, a second time to acquire resources from outside the cluster to execute the user workload; and
based on comparing the first time to the second time, performing one of:
delaying scale-out for the user workload based on the first time being less than the second time; and
performing the scale-out for the user workload based on the first time being greater than the second time.

12. The computer program product of claim 11, wherein a carbon intensity value is an input to the second machine learning model.

13. The computer program product of claim 11, wherein the user workload comprises a foundational model workload.

14. The computer program product of claim 11, wherein the resources from outside the cluster comprise one or more graphics processing units that are not currently in the cluster.

15. The computer program product of claim 11, wherein the similarity analysis is based on a first set of resources used by the current workload and a second set of resources associated with the user workload.

16. A computer system comprising:
a processor set;
one or more computer-readable storage media; and
program instructions stored on the one or more computer-readable storage media to cause the processor set to perform operations comprising:
queuing a user workload in a cluster in a containerized environment in a distributed computing environment;
identifying a current workload in the cluster using a similarity analysis;
predicting, using a first machine learning model, a first time to complete execution of the current workload;
predicting, using a second machine learning model, a second time to acquire resources from outside the cluster to execute the user workload; and
based on comparing the first time to the second time, performing one of:
delaying scale-out for the user workload based on the first time being less than the second time; and
performing scale-out for the user workload based on the first time being greater than the second time.

17. The computer system of claim 16, wherein a carbon intensity value is an input to the second machine learning model.

18. The computer system of claim 16, wherein the user workload comprises a foundational model workload.

19. The computer system of claim 16, wherein the resources from outside the cluster comprise one or more graphics processing units that are not currently in the cluster.

20. The computer system of claim 16, wherein the similarity analysis is based on a first set of resources used by the current workload and a second set of resources associated with the user workload.
